(19) United States
(12) Patent Application Publication
(10) Pub. No.: US 2011/0166873 A1
(43) Pub. Date: Jul. 7, 2011

(54) PATIENT-SPECIFIC RESEARCH CONSENT MANAGER

(75) Inventors: SARA J. GRIFFIN, LEE'S SUMMIT, MO (US); SARA J. BOSWELL, BLUE SPRINGS, MO (US)

(73) Assignee: CERNER INNOVATION, INC., Overland Park, KS (US)

(21) Appl. No.: 12/982,668

(22) Filed: Dec. 30, 2010

Related U.S. Application Data
(60) Provisional application No. 61/291,710, filed on Dec. 31, 2009.

(51) Int. Cl. G06Q 50/00; G06Q 10/00

(52) U.S. Cl. 705/2

(57) ABSTRACT

Methods, systems, and computer storage media are provided for managing patient-specific research consents. In embodiments, the present invention gives health care providers the ability to view a participant's up to date consent information and documentation within their clinical workflow.

### CROSS-REFERENCE TO RELATED APPLICATION

This application claims the benefit of U.S. Provisional Application Ser. No. 61/291,710, filed Dec. 31, 2009, which is hereby incorporated by reference in its entirety.

### BACKGROUND

Clinical trials are biomedical and health-related research studies directed towards the development of new drugs and medical treatments. Clinical trials are generally conducted by healthcare providers such as doctors, nurses, and researchers (collectively, “clinicians”) are who are looking for new and innovative ways for treating different types of illnesses. Healthy and non-healthy individuals can benefit greatly from participation in clinical trials. For example, it allows them to play an active role in their own health care, it gives them access to new research treatments before they are widely available, and it allows them to obtain medical care at leading health care facilities. At the same time, there are also risks associated with participation. These risks include unpleasant, serious or even life-threatening side effects, lack of effectiveness, and the protocol may require more of the participant's time and attention than normal treatment. Clinical trials are a highly structured and regulated because of these risks and benefits.

The structure and quality of the clinical trial is ensured by following a pre-defined protocol throughout the process. The protocol is a study plan on which the clinical trial is based. It is designed to safeguard the health of the participants and answer particular research questions. It also sets the criteria for the types of people that may participate; it describes the schedule of tests, procedures, medications, and dosages; and it details the length of the study. For each protocol a participant will need to sign one or more informed consent documents before the clinical trial can begin. The informed consent documents essentially describes to the participant all or part of the protocol, plus risks and potential benefits of the trial. A participant can sign informed consent documents before or after he is enrolled in the trial, but test and procedures cannot begin until the document is signed.

During the administration of care, health care providers have to be aware of which consent documents the patient (participant) has signed in order to proceed with treatment related to the clinical trial. Having visibility to consent a document and its status can enhance patient safety, mitigate liability and risk, and provide for a faster more efficient execution of the clinical trial. The current state of the art inhibits this capability because patient consent information is documented within a separate Clinical Trial Management System (CTMS) and is available only to users that have access. This creates a partitioned system that separates the clinical research and compliance from the clinical care.

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention provide a mechanism for managing patient-specific research consents. In embodiments, the present invention gives health care providers (clinicians) the ability to view a participant's (patient's) up to date consent information and documentation within their clinical workflow. The health care provider can view consent information within the context of the clinical trials or a specific participant's electronic medical record (health record).

In one aspect, a method for managing patient-specific clinical research consents involves: receiving clinical research consent information for a particular patient where the information includes distinct consents each relating to a specific protocol, storing associations between the distinct consents and the specific protocols, and presenting the distinct consents for a particular patient along with an electronic medical record of the particular patient accessed on a medical information system.

### BRIEF DESCRIPTION OF THE DRAWINGS

The present invention is described in detail below with reference to the attached drawing figures, wherein:

FIG. 1 is a block diagram of an exemplary computing environment suitable for use in implementing the present invention;

FIG. 2 is a logical depiction of protocols associated with a particular patient and corresponding consents and consent documents;

FIG. 3 is a flow diagram illustrating a clinician workflow for enrolling a patient in a particular clinical research activity having multiple protocols and associated consents;

FIG. 4 is a screenshot illustrating an exemplary clinical research activity manager presenting a view of all patients enrolled;

FIG. 5 is a screenshot illustrating an exemplary clinical research activity manager presenting a view of patients having returned consent documents;

FIG. 6 is a screenshot illustrating an exemplary clinical research activity manager presenting a view of patients with consents pending signature;

FIG. 7 is a screenshot illustrating an exemplary clinical research activity manager presenting a view of patients with consent documents not returned;

FIG. 8 is a screenshot illustrating a view of information regarding a patient's involvements in clinical research presented in the context of the patient's electronic health record;

FIG. 9 is a screenshot illustrating a exemplary view of clinical research consent information for a particular patient;

FIG. 10 is a screenshot illustrating a exemplary view of clinical research consent information for a particular patient filtered to display only signed documents;

FIG. 11 is a screenshot illustrating an example of an electronic version of a selected consent document; and

FIG. 12 is a flow diagram illustrating a method for managing patient-specific clinical research consents, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

Embodiments of the present invention provide for systems, methods, and computer storage media for managing patient-specific clinical research consents. Accordingly, a particular patient has various protocols (associated with one or more clinical research activities) linked to them. One or more consents are associated with each protocol, and the status of those consents for the particular patient are tracked (e.g., signed consent, consent released to the patient but not yet signed, consent not returned). Clinicians can view the consents for each protocol for the particular patient, as well as an electronic version of any template consent documents or signed consent documents.

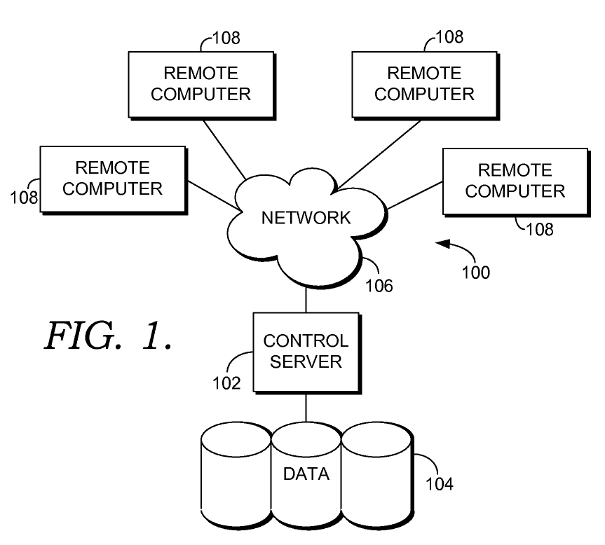

Having briefly described embodiments of the present invention, an exemplary operating environment suitable for use in implementing embodiments of the present invention is described below. Referring to the drawings in general, and initially to FIG. 1 in particular, an exemplary computing system environment, for instance, a medical information computing system, on which embodiments of the present invention may be implemented is illustrated and designated generally as reference numeral 100. It will be understood and appreciated by those of ordinary skill in the art that the illustrated medical information computing system environment 100 is merely an example of one suitable computing environment and is not intended to suggest any limitation as to the scope of use or functionality of the invention. Neither should the medical information computing system environment 100 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary medical information computing system environment 100 includes a general purpose computing device in the form of a server 102. Components of the server 102 may include, without limitation, a processing unit, internal system memory, and a suitable system bus for coupling various system components, including database cluster 104, with the server 102. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The server 102 typically includes, or has access to, a variety of computer-readable media, for instance, database cluster 104. Computer-readable media can be any available media that may be accessed by server 102, and includes volatile and nonvolatile media, as well as removable and non-removable media. By way of example, and not limitation, computer-readable media may include computer storage media and communication media. Computer storage media may include, without limitation, volatile and nonvolatile media, as well as removable and nonremovable media implemented in any method or technology for storage of information, such as computer-readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the server 102. Communication media typically embodies computer-readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

The computer storage media discussed above and illustrated in FIG. 1, including database cluster 104, provide storage of computer-readable instructions, data structures, program modules, and other data for the server 102.

The server 102 may operate in a computer network 106 using logical connections to one or more remote computers 108. Remote computers 108 may be located at a variety of locations in a medical or research environment, for example, but not limited to, clinical laboratories, hospitals and other inpatient settings, veterinary environments, ambulatory settings, medical billing and financial offices, hospital administration settings, home healthcare environments, and clinicians' offices. Clinicians may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, genetic counselors, researchers, veterinarians, students, and the like. The remote computers 108 may also be physically located in nontraditional medical care environments so that the entire healthcare community may be capable of integration on the network. The remote computers 108 may be personal computers, servers, routers, network PCs, peer devices, other common network nodes, or the like, and may include some or all of the components described above in relation to the server 102. The devices can be personal digital assistants or other like devices.

Exemplary computer networks 106 may include, without limitation, local area networks (LANs) and/or wide area networks (WANs). Such networking environments are commonplace in offices, enterprise-wide computer networks, intranets, and the Internet. When utilized in a WAN networking environment, the server 102 may include a modem or other means for establishing communications over the WAN, such as the Internet. In a networked environment, program modules or portions thereof may be stored in the server 102, in the database cluster 104, or on any of the remote computers 108. For example, and not by way of limitation, various application programs may reside on the memory associated with any one or more of the remote computers 108. It will be appreciated by those of ordinary skill in the art that the network connections shown are exemplary and other means of establishing a communications link between the computers (e.g., server 102 and remote computers 108) may be utilized.

In operation, a user may enter commands and information into the server 102 or convey the commands and information to the server 102 via one or more of the remote computers 108 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the server 102. In addition to a monitor, the server 102 and/or remote computers 108 may include other peripheral output devices, such as speakers and a printer.

Although many other internal components of the server 102 and the remote computers 108 are not shown, those of ordinary skill in the art will appreciate that such components and their interconnection are well known. Accordingly, additional details concerning the internal construction of the server 102 and the remote computers 108 are not further disclosed herein.

As previously mentioned, embodiments of the invention relate to a mechanism for managing patient-specific research consents. Patient health record data resides at least in person-centric electronic medical or health records, such that each individual of a pool of individuals has such a health record. The term “health record” or “chart” is not meant to be limited to any particular type of unified record that stores health data for an individual, examples of which include an electronic medical record (EMR), electronic health record (EHR), personal health record (PHR), continuity of care record (CCR), among others, or any portion thereof, such as a medication administration record (MAR or eMAR). Furthermore, the terms “patient”, “individual”, “participant” and “person” may be used interchangeably herein to refer to someone who has an associated medical or health record.

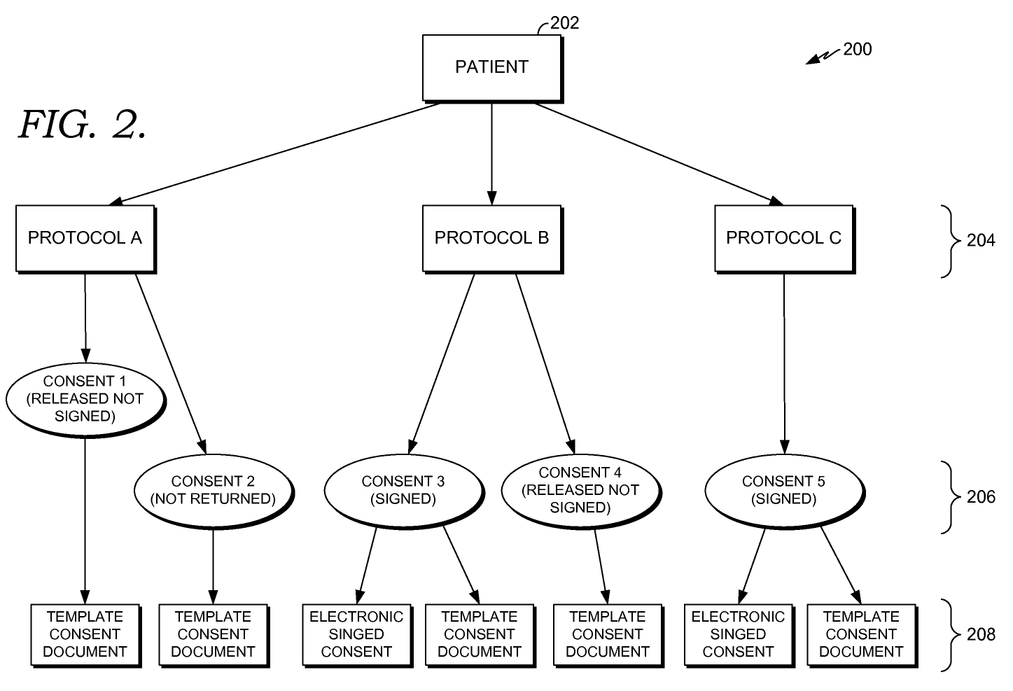

Turning now to FIG. 2, diagram 200 depicts the organization of clinical research consent information for a particular patient 202. Through enrollment in one or more clinical research activities (e.g., clinical trial or other clinical study), the patient 202 becomes associated with one or more protocols 204. Each protocol 204 has one or more consents 206 associated therewith that are necessary to fully carry out the protocol. The consents 206, in one embodiment, have different conditions associated therewith. For instance, the consent status may be “Signed” if the patient has properly signed and returned the particular consent document(s) that are necessary, “Released Not Signed” if consent document(s) were provided to the patient but have not been returned, or “Not Returned” if a pre-established period of time has elapsed since consent documents(s) were provided to the patient and such document(s) have not been returned. Standard procedure is to have each necessary consent document signed by the patient and documented (e.g., through medical information computing system 100) before moving forward with the associated protocol 204. Electronic copies of consent documents 208 for each type of consent 206 are also tracked. Consent documents 208 that are viewable include template consent documents and signed consent documents. Each template consent document represents a standard form of a document that patients must sign for a given consent and protocol (e.g., Consent 1, Protocol A of FIG. 2). The signed consent documents may take the form of electronic scanned copies of physical documents signed by the patient and input into the medical information computing system 100, or electronic documents digitally signed by the patient.

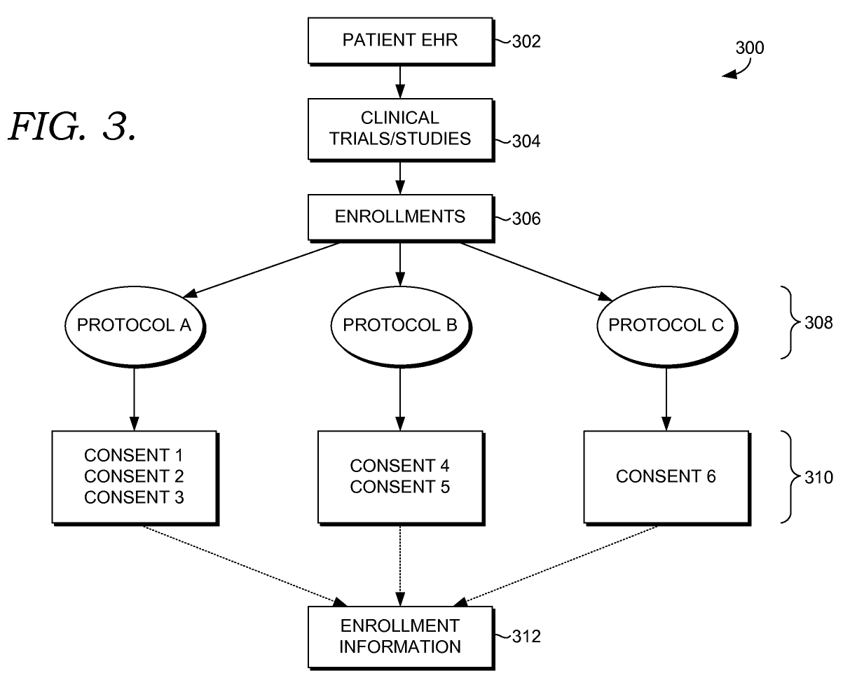

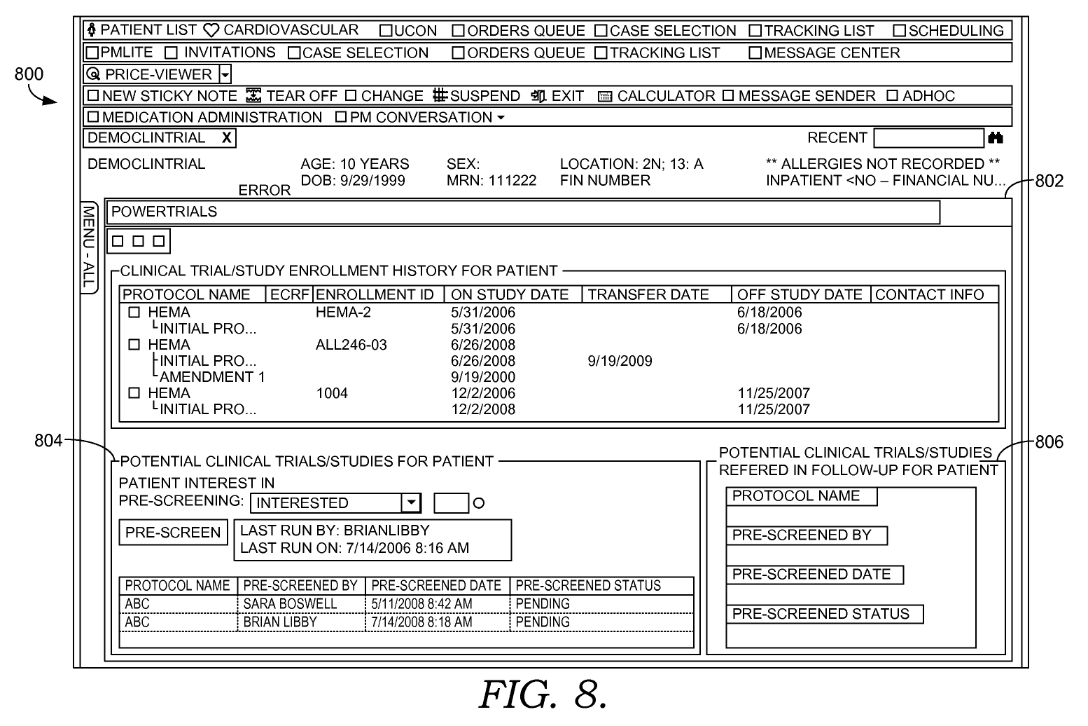

FIG. 3 provides a clinician workflow 300 for enrolling a patient in a clinical research activity (i.e., clinical trial/study). From a particular patient's electronic health record 302, the clinician can navigate to a clinical trial manager 304 (as depicted in FIG. 8 and discussed herein below) and select to begin an enrollment process 306 for the specific patient while remaining in the context of that patient's health record. One or more specific protocols 308 are available for patient enrollment, with each protocol 308 having one or more distinct consents 310 that must be agreed to (signed) by the patient in order to fully participate in the activities described in the corresponding protocol(s). Accordingly, the particular protocol(s) 308 and consent(s) 310 drive enrollment information 312 that is viewable by the clinician in the context of the particular patient's health record.

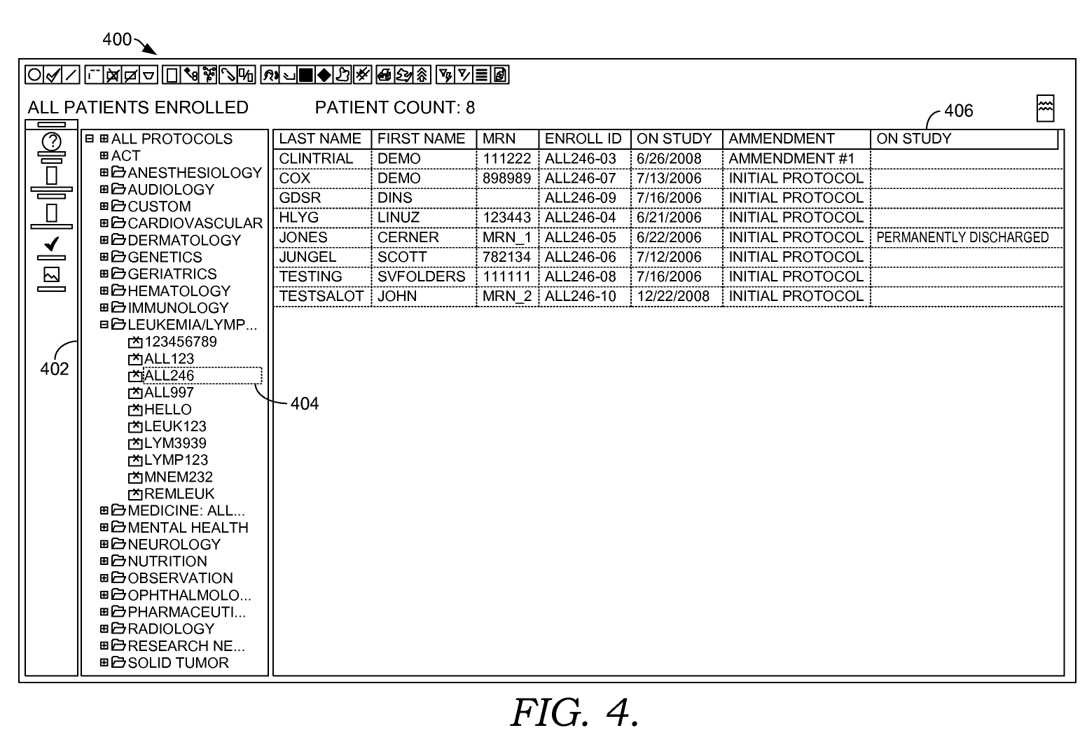

Turning now to FIG. 4, an exemplary view 400 of a clinical research activity (clinical trial) manager. View 400 includes a first display area 402 presenting a list of protocols for available clinical trial enrollment. Within the list, the ALL246 protocol selection 404 in the category of LEUKEMIA/LYMPHOMA enables viewing of all patients enrolled in that particular protocol. Second display area 406 provides the list of patients enrolled on the ALL246 protocol and associated enrollment information.

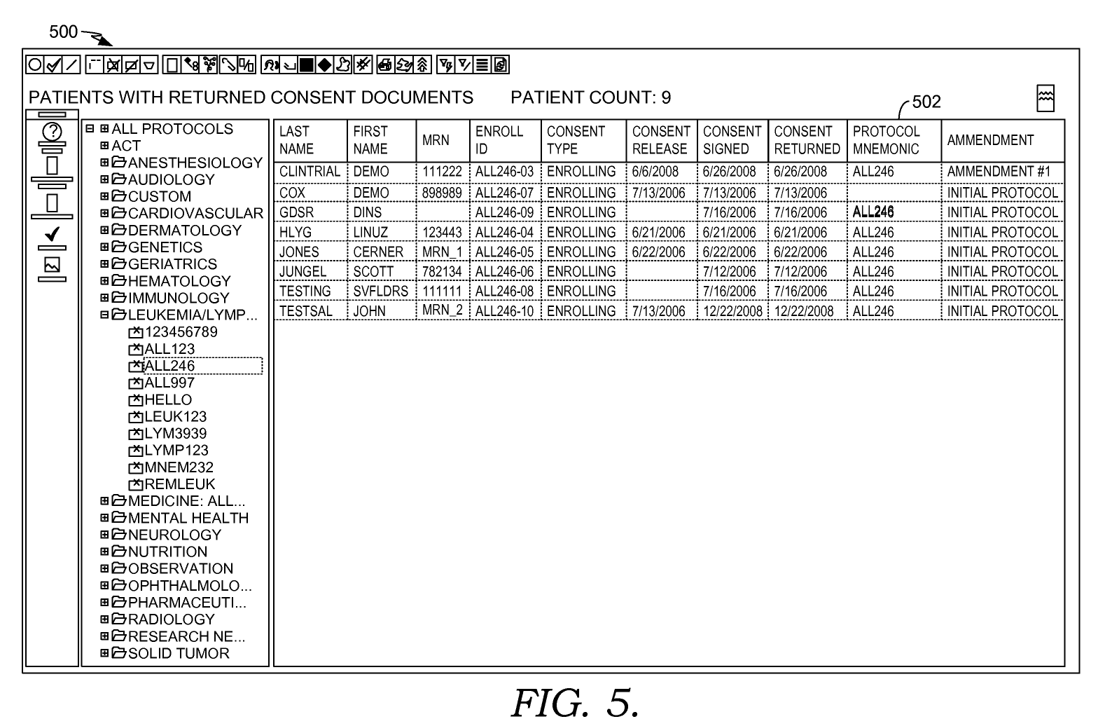

FIG. 5 provides another exemplary view 500 of a clinical research activity manager. View 500 is similar to view 400 of FIG. 4, but is distinguished by first display area 502 providing a filtered patient list. Specifically, first display area 502 shows patients with returned consent documents for the selected ALL246 protocol, as opposed to all patients enrolled in selected protocol. For each patient listed in first display area 502, documented consent information is provided, such as patient identifying information, the type of consent, dates of consent release to the patient and when the patient signs and returns the release, etc.

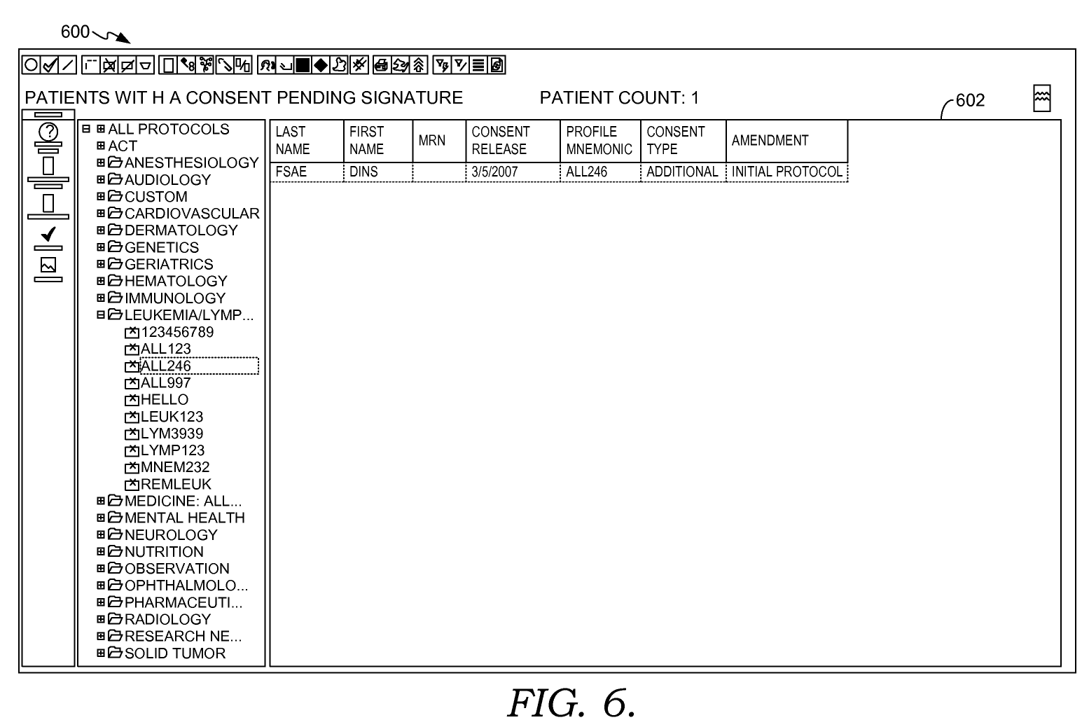

FIG. 6 provides another exemplary view 600 of a clinical research activity manager, similar to view 400 of FIG. 4 and view 500 of FIG. 5. View 600 is distinguished by providing another type of filtered patient list. Specifically, a first display area 602 shows patients with a consent document pending signature for the selected ALL246 protocol.

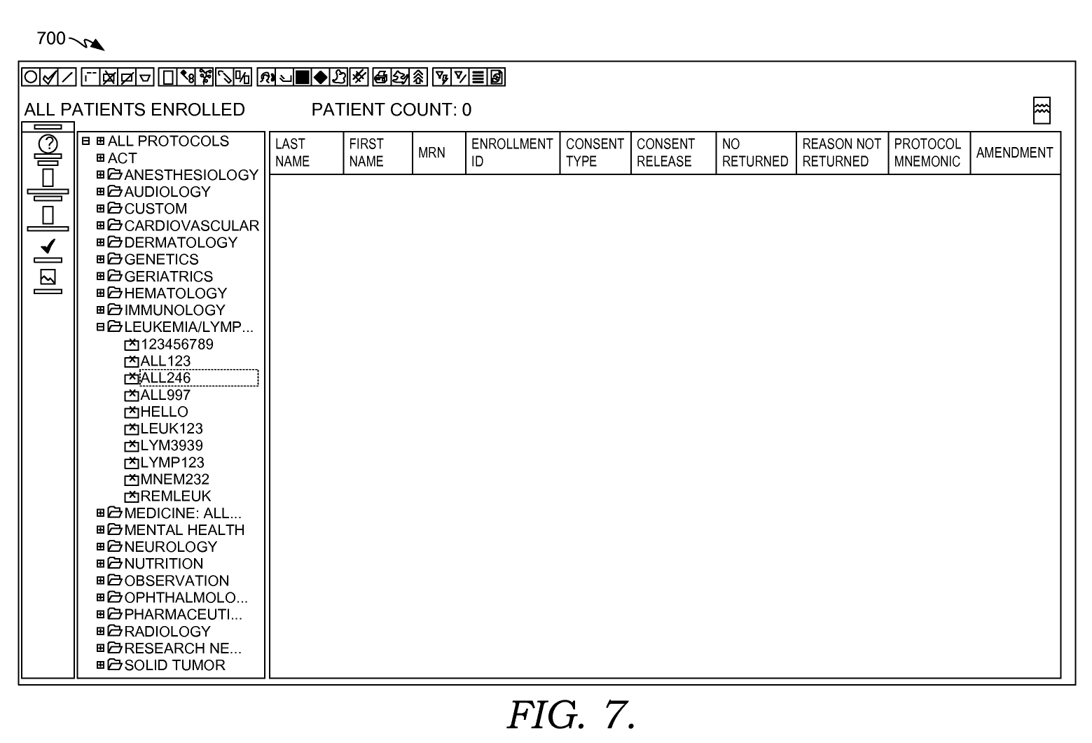

Similar to the aforementioned views 400, 500 and 600 in FIGS. 4-6, respectively, FIG. 7 provides another exemplary view 700 of a clinical research activity manager. View 700 is distinguished by providing another type of filtered patient list, in this case patients with consent documents not returned. Specifically, a first display area 702 shows patients with a consent document pending signature for the selected ALL246 protocol.

Turning now to FIG. 8, an exemplary view 800 of a clinical trial manager (e.g., clinical trial manager 304 of FIG. 3) integrated within the context of a particular patient's electronic health record is provided. View 800 includes a first display area 802 providing clinical trial/study enrollment history for the specific patient, including protocol information and other trial/study details. A second display area 804 provides potential clinical trials/studies for the particular patient, including trials/studies for which the patient has been pre-screened. Specifically, protocols are displayed for which the patient meets certain qualifications. This enables the clinician utilizing the clinical trial manager to suggest specific trials/studies for the patient. A third display area 806 lists any potential clinical trials/studies referred in follow-up for the patient. Accordingly, the clinical trial information displayed in view 800 is accessed directly from the particular patient's electronic health record.

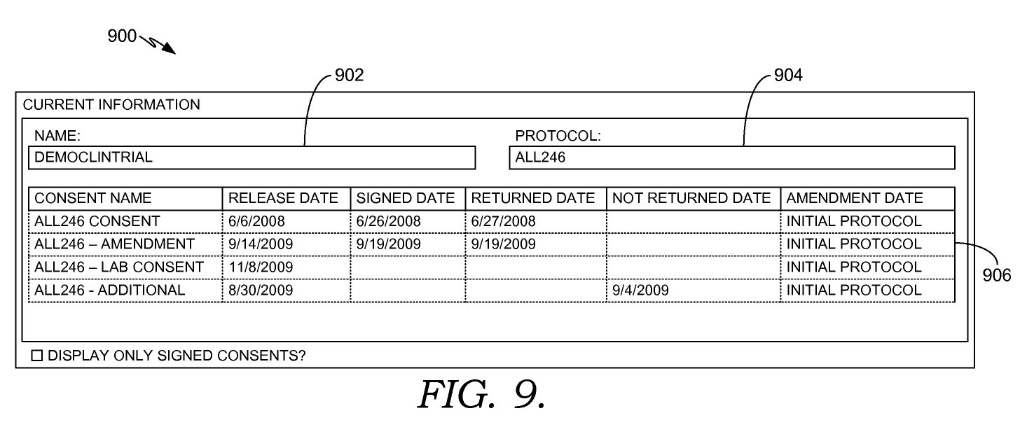

By selecting particular protocols in the first display area 802 of view 800, the clinician can navigate to particular consent documents associated with each of such protocols. Specifically, FIG. 9 provides an exemplary view 900 of consent document information associated with a selected clinical trial 902 and protocol 904. First display area 906 lists each named consent and other relevant information specific to the associated patient, such as the consent document release date, signed date, date of return of the signed document or date when it is confirmed the consent document will not be signed (or a date a specified amount of time in the future from the release date), and any date the consent was amended.

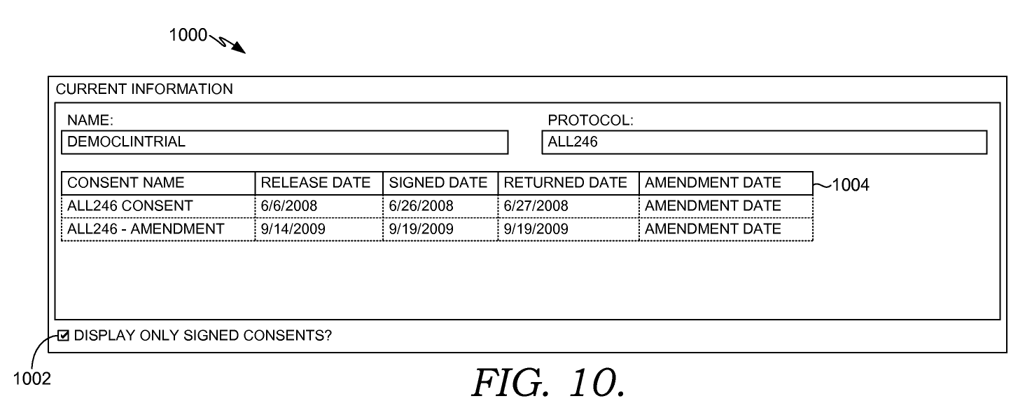

FIG. 10 provides another exemplary view 1000 of consent document information associated with a selected clinical trial and protocol, similar to view 900 of FIG. 9. View 1000 is distinguished by selector 1002 that filters a list of named consents displayed in a first display area 1004 for the particular patient to only show consent documents that are confirmed as being signed by the patient.

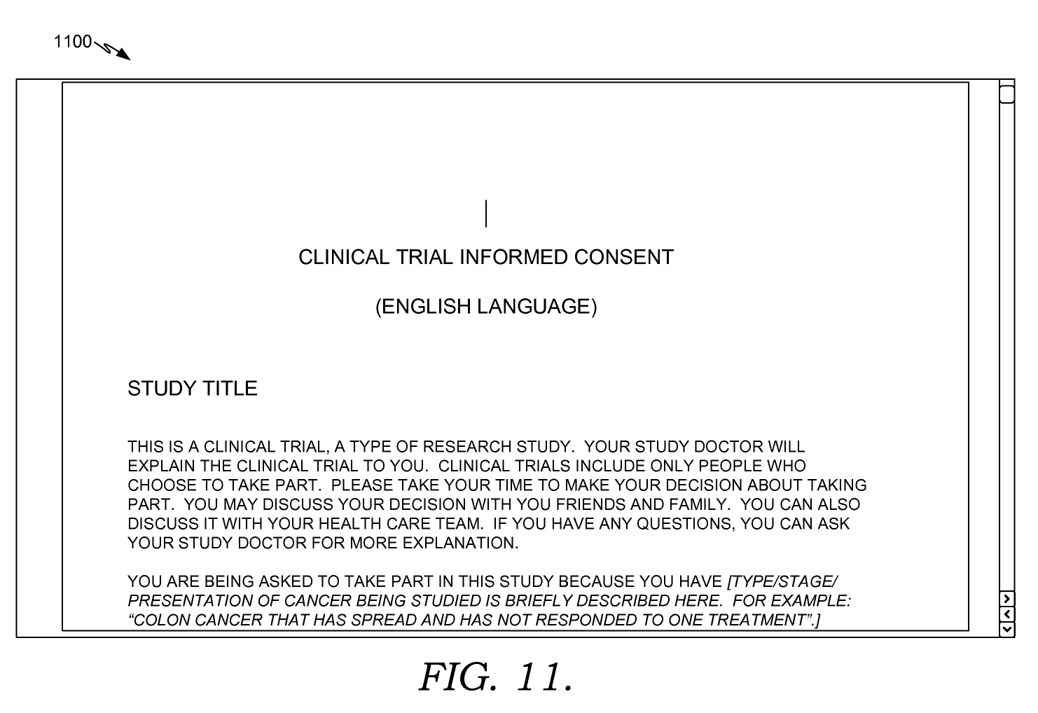

Upon the selection of a particular named consent in first display area 906 of FIG. 9 or first display area 1004 of FIG. 10, an electronic version of a consent document associated with the named consent is displayed in exemplary view 1100 of FIG. 11. The consent document may be, for instance, a template consent document or a signed consent document from the particular patient.

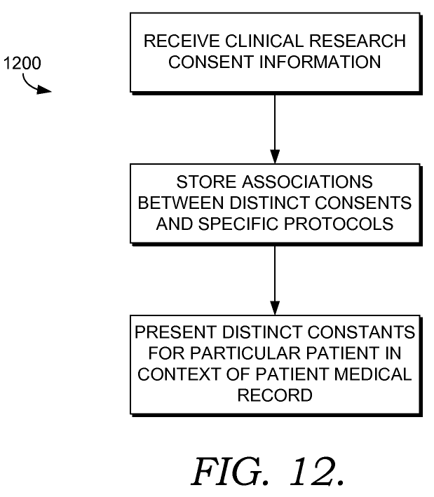

Turning now to FIG. 12, a flow diagram showing a method 1200 for managing patient-specific clinical research consents, in accordance with an embodiment of the present invention, is provided. Initially, at block 1202, clinical research consent information for a particular patient is received. At block 1204, associations between distinct consents and specific protocols are stored. Thereafter, at block 1206, distinct consents for the particular patient may be presented in context of the patient's health (medical) record.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated and within the scope of the claims.

What is claimed is:

1. A method for managing patient-specific clinical research consent, comprising:
receiving clinical research consent information for a particular patient, wherein the clinical research consent information includes distinct consents each relating to a specific protocol of a plurality of protocols;
storing associations between the distinct consents and the specific protocols; and
selectively presenting the distinct consents for the particular patient along with a record of the particular patient accessed on a medical information system.

2. The method of claim 2, wherein selectively displaying the distinct consents includes displaying one or more distinct consents that are relevant to a current patient context associated with the record of the particular patient.

3. The method of claim 2, wherein one or more of the specific protocols of the plurality of protocols are associated with one or more specific clinical trials.
